(19) United States
(12) Patent Application Publication
(10) Pub. No.: US 2006/0218413 A1
(43) Pub. Date: Sep. 28, 2006

(54) Method of introducing physical device security for digitally encoded data

(75) Inventors: Kameron Bruce Romines, Tacoma, WA (US); Michael John Weisskopf, Seabrook, TX (US); Michael Lindsey Williams, Seabrook, TX (US)

Correspondence Address: RICHARD M. GOLDMAN, 371 ELAN VILLAGE LANE, SUITE 208, SAN JOSE, CA, 95134, US

(73) Assignee: International Business Machines Corporation, Armonk, NY (US)

(21) Appl. No.: 11/086,183

(22) Filed: Mar. 22, 2005

(51) Int. Cl. G06F 12/14

(52) U.S. Cl. 713/193

(57) ABSTRACT

Securing and accessing digital data by encrypting the digital data with a digital key. The encrypted data is striped across a plurality of physical data storage devices. A key is required to access the digital data. This is done by applying the digital key access the encrypted data across all of the physical data storage devices when all of the physical data storage devices are simultaneously present.

### BACKGROUND

1. Field of the Invention

The invention relates to data security, and more particularly to data security in striped data systems.

2. Background of the Invention

Digital security is largely reliant upon software protection, such as PGP. Those systems typically breakdown into digital signatures and username/password solutions. Typically, they are single user in nature. That is, any user who has knowledge of the password and private key may gain access to the protected information.

Thus, a need exists to be able to secure information such that access to that information requires the actual, physical presence of a set of individuals, that is, a plurality of individuals, so that no subset of less then all of the individuals may access the information.

### SUMMARY OF THE INVENTION

These and other problems are obviated by the method, system, and program product described herein. Specifically, the invention described herein provides a method of securing and accessing digital data. This is done by encrypting the digital data with a digital key. Next, the encrypted digital data is striped across a plurality of physical data storage devices, where the digital devices require a key for access to the digital data. Next the digital key is applied to access the encrypted data when all of the physical data storage devices are simultaneously present.

### FIGURES

Various aspects of the invention are illustrated in the figures appended hereto.

FIG. 1 illustrates a high level flow chart of the invention, with the steps of encrypting the data with a digital key, striping the encrypted data across a plurality of physical data storage devices that require the digital key for access to the stored data, and applying the digital key to access the encrypted data across all of the physical data storage devices when all of the digital data storage devices are simultaneously present.

FIG. 2 illustrates the concept of striping where data, illustrated as text data, is encrypted, here simply by breaking the text data into groups of four characters, and then storing the encrypted data into different media.

FIG. 3 illustrates a system of the invention, with a server, a plurality of physical data storage devices, and data access terminals with means for inserting a storage medium carrying the digital key.

### DETAILED DESCRIPTION

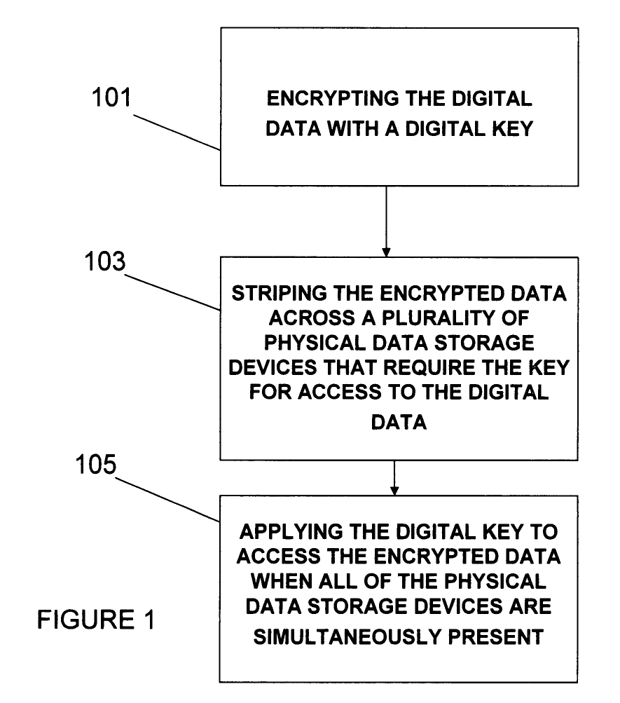

These and other problems are obviated by the method, system, and program product described herein. Specifically, the invention described herein provides a method of securing and accessing digital data, as illustrated in FIG. 1. This is done by encrypting the digital data with a digital key 101. Next, the encrypted digital data is striped across a plurality of physical data storage devices 103, where the digital devices each require a key for access to the digital data. Finally, the digital key is applied to access the encrypted data when all of the physical data storage devices are simultaneously present to access the data 107.

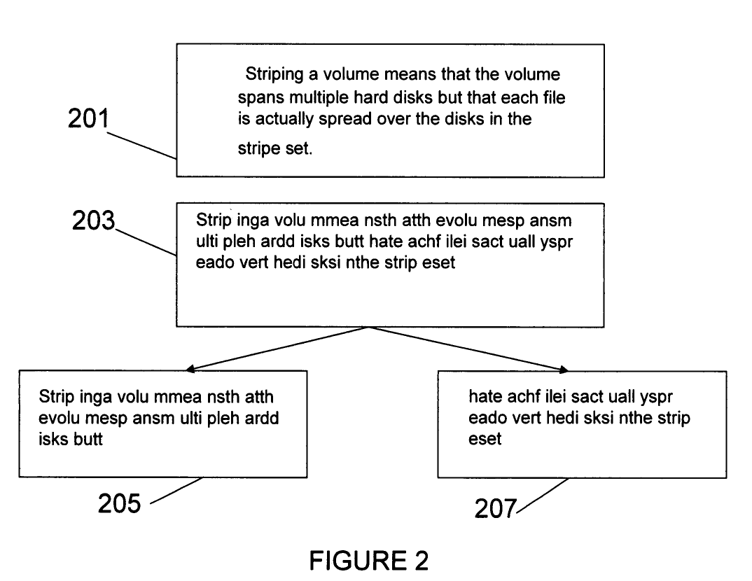

As shown in FIG. 2, striping a volume means that the volume spans multiple storage media, such as USB devices, flash memories, hard disks, or the like, but that each file is actually spread over the disks in the stripe set. As shown in FIG. 2 the data 201, illustrated as text data, is encrypted, here simply by breaking the text data into groups of four characters 203, and then the encrypted data is stored or written into different physical data storage devices 205 and 207. This means that performance may be dramatically increased because files are read from and written to multiple hard disks or flash memories simultaneously. For example, if there is a stripe set consisting of three hard disks, then one third of the file would be on each disk. The individual physical data storage devices of the plurality of physical data storage devices are individually removable. The digital data itself is spread across all of the physical data storage devices. In this way all of the physical data storage devices are required to be present and active in order for a user to access the digital data. To access the digital data the digital key is simultaneously applied to all of the physical data storage devices when all of the physical data storage devices are simultaneously present.

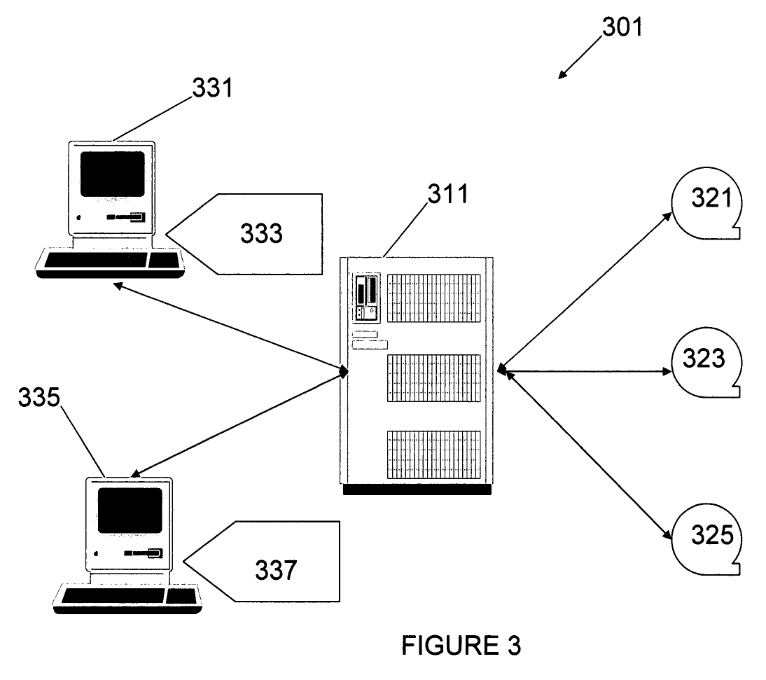

A further aspect of the invention, illustrated in FIG. 3, is a data storage system 301 having a server 311 and a plurality of separate, individual memory devices 321, 323, and 325. These devices 321, 323, and 325 are adapted for striped storage of encrypted digital data. The individual data storage devices, 312, 323, and 325 are illustrated as disks, but may be USB devices, flash memories, tape drives, or the like. The physical storage devices, 321, 323, and 325 are individually removable. The system also includes means, such as terminals 331 and 335 for simultaneously applying a digital key, e.g., manually by a keyboard or touch screen entry, or by a simple memory devices, 333 and 337, such as a magnetic card or a flash memory card, to access the encrypted data when all of the physical data storage devices, 321, 313, and 325, are simultaneously present. The readers, terminals, or other access and output devices 331 and 335 are for simultaneously reading the encrypted data when all of the physical storage devices are simultaneously present.

The system is for full striping of encrypted data across all of the physical data storage devices. This is so that the digital key is applied to all of the physical storage devices to access the encrypted data only when all of the physical storage devices are simultaneously present. This is accomplished through a hardware or software interlock that precludes access when less then all of the physical storage devices are present.

The invention may be implemented, for example, by having the system for securing and accessing digital data, e.g., by encrypting the digital data with a digital key, striping the encrypted data across a plurality of physical data storage devices requiring the key for access to the digital data; and applying the digital key to access the encrypted data when all of the physical data storage devices are simultaneously present. This is accomplished by executing the method as a software application, in a dedicated processor, or in a dedicated processor with dedicated code. The code executes a sequence of machine-readable instructions, which can also be referred to as code. These instructions may reside in various types of signal-bearing media. In this respect, one aspect of the present invention concerns a program product, comprising a signal-bearing medium or signal-bearing media tangibly embodying a program of machine-readable instructions executable by a digital processing apparatus to perform a method for securing and accessing digital data as a software application.

This signal-bearing medium may comprise, for example, memory in a server. The memory in the server may be non-volatile storage, a data disc, or even memory on a vendor server for downloading to a processor for installation. Alternatively, the instructions may be embodied in a signal-bearing medium such as the optical data storage disc. Alternatively, the instructions may be stored on any of a variety of machine-readable data storage mediums or media, which may include, for example, a “hard drive”, a RAID array, a RAMAC, a magnetic data storage diskette (such as a floppy disk), magnetic tape, digital optical tape, RAM, ROM, EPROM, EEPROM, flash memory, magneto-optical storage, paper punch cards, or any other suitable signal-bearing media including transmission media such as digital and/or analog communications links, which may be electrical, optical, and/or wireless. As an example, the machine-readable instructions may comprise software object code, compiled from a language such as “C++”, Java, Pascal, ADA, assembler, and the like.

Additionally, the program code may, for example, be compressed, encrypted, or both, and may include executable code, script code and wizards for installation, as in Zip code and cab code. As used herein the term machine-readable instructions or code residing in or on signal-bearing media include all of the above means of delivery.

While the foregoing disclosure shows a number of illustrative embodiments of the invention, it will be apparent to those skilled in the art that various changes and modifications can be made herein without departing from the scope of the invention as defined by the appended claims. Furthermore, although elements of the invention may be described or claimed in the singular, the plural is contemplated unless limitation to the singular is explicitly stated.

We claim:

1. A method of securing and accessing digital data comprising:
a) encrypting the digital data with a digital key;
b) striping said encrypted data across a plurality of physical data storage devices requiring said key for access to the digital data; and
c) applying said digital key to access said encrypted data when all of said physical data storage devices are simultaneously present.

2. The method of claim 1 wherein said plurality of physical data storage devices are removable.

3. The method of claim 1 wherein said digital data is spread across all of the physical data storage devices whereby all of the physical data storage devices are required in order to access the digital data.

4. The method of claim 3 comprising simultaneously applying said digital key to all of said physical data storage devices to access said encrypted data when all of said physical data storage devices are simultaneously present.

5. A data storage system comprising a plurality of separate, individual memory devices for striped storage of encrypted digital data;
a) means for simultaneously applying a digital key to access said encrypted data when all of said physical data storage devices are simultaneously present; and
b) means for simultaneously reading said encrypted data only when all of said physical data storage devices are simultaneously present.

6. The data storage system of claim 5 wherein the physical data storage devices are individually removable.

7. The data storage system of claim 5, said system being adapted for full striping of encrypted data across all of said physical data storage devices.

8. The data storage system of claim 7, said system being adapted for simultaneously applying said digital key to all of said physical data storage devices to access said encrypted data only when all of said physical data storage devices are simultaneously present.

9. A program product comprising computer readable program code for use with a data storage system comprising a plurality of separate, individual memory devices for striped storage of encrypted digital data, and having means for simultaneously applying a digital key to access said encrypted data when all of said physical data storage devices are simultaneously present; and means for simultaneously reading said encrypted data only when all of said physical data storage devices are simultaneously present, said program code causing said data storage system to secure and access digital data by a method comprising:
a) encrypting the digital data with a digital key;
b) striping said encrypted data across a plurality of physical data storage devices requiring said key for access to the digital data; and
c) applying said digital key to access said encrypted data when all of said physical data storage devices are simultaneously present.

10. The program product of claim 9 wherein said plurality of physical data storage devices are removable.

11. The program product of claim 9 comprising program code for spreading said encrypted data across all of the physical data storage devices whereby all of the physical data storage devices are required in order to access the digital data.

12. The program product of claim 11 comprising program code for simultaneously applying said digital key to all of said physical data storage devices to access said encrypted data when all of said physical data storage devices are simultaneously present.
